(19) United States
(12) Patent Application Publication
(10) Pub. No.: US 2025/0108242 A1
(43) Pub. Date: Apr. 3, 2025

(54) ELECTRICALLY TRIGGERED FIRE-EXTINGUISHING DEVICE

(71) Applicant: Yuriy Alexandrovich Gabliya, Moscow (RU)

(72) Inventor: Evgenii Sergee KAPLUN, Malaya Tsarevshchina (RU)

(21) Appl. No.: 18/862,150

(22) PCT Filed: Mar. 24, 2023
(86) PCT No.: PCT/RU2023/000078

§ 371 Date: Oct. 31, 2024

(30) Foreign Application Priority Data
May 23, 2022 (RU) 2022113745

(51) Int. Cl. A62C 37/36; A62C 37/11

(52) U.S. Cl. CPC A62C 37/04; A62C 37/11

(57) ABSTRACT

The present patent application relates to the field of electrical engineering and power engineering and can be used for the timely emergency shutdown of electrical equipment. The invention relates to a fire-extinguishing device having disposed therein a module (1) which contains an aerosol-forming or gas-forming composition, and comprising an electrical igniter (7) of said module (1) and a heat-sensitive trigger device (4), which are connected to one another in series by conductors, wherein the device further comprises: a contact group (10) for triggering, over conductors by means of an external signal, the electrical igniter (7) of the module, or for supplying a trigger voltage to the heat-sensitive trigger device (4) and the electrical igniter (7) of the module; an activation sensor (11), and a button (18) for manually activating the electrical igniter (7) of the module (1); the activation sensor (11) is connected by conductors (17) to the contact group (10); and the button (18) for manually activating the electrical igniter (7) of the module is connected by conductors to the electrical igniter (7) of the module. The technical result consists in increasing the timeliness of an initial fire-extinguishing action and more efficiently impeding the spread of fire in an enclosed space such as, in particular, an electrical enclosure, while simultaneously issuing a signal to trigger such fire-extinguishing devices, or issuing an information signal to emergency control panels.

### FIELD OF INVENTION

The invention relates to fire-extinguishing devices based on aerosol-forming or gas-forming compounds and can be used to prevent fires in electrical switchboards, safes, cabinets with electrical equipment, cabinets of telecommunications and other electronic equipment located in confined spaces and technical compartments.

When operating electrical equipment, fire often occurs which causes are as follows: overload of electrical installations and wiring, short circuit, ignition of combustible materials near equipment connected to the network, excessive transient resistance in the contact groups of electrical wiring.

It is necessary to duly and automatically suppress the fire at the incipient stage without voltage removal and human intervention, eliminating the possibility of electric shock and preserving expensive equipment.

### STATE OF ART

The fire-extinguishing means that are known from the background of invention and designed to suppress fire in electrical installations are presented below.

An autonomous fire-extinguishing plant based on a thermally activated agent contained in microcapsules (patent RU 179466) which is made of a polymer composite plate having a regular surface relief and containing microcapsules with a fire-extinguishing agent placed in a special organosilicon compound. The substrate of the plate on the reverse side has a heat-resistant self-adhesive layer for its fastening in the protected volume. Microcapsules of 50-400 microns are used as a fire-extinguishing agent, having a core of a fire-extinguishing ozone-safe liquid placed inside a spherical polymer shell (patent RU 2469761). Microcapsules are capable of explosive destruction when the temperature reaches 90° C. This fire-extinguishing system is characterized by a low extinguishing capacity and a short service life (as the application practice shows, it is no more than two years) which is a significant disadvantage.

An autonomous gas fire-extinguishing plant (patent RU 139678) which comprises a cylinder with a gas-extinguishing agent (for example, halon), communicating with a main for supplying a fire-extinguishing medium to a protected volume designed using a fusible polymer material. The main is connected to the cylinder by a shut-off and starting device with a pressure gauge and a ball valve, and is also equipped with an elastic outer shell in the form of a metal spiral. This fire-extinguishing plant is characterized by multicomponence and high complexity of installation in a protected volume.

A mean of fastening a fire-extinguishing wire in an electric cabinet is known (patent RU 190409). A fire-extinguishing wire or pyrowire is an autonomous fire-extinguishing plant with a thermally activated microcapsulated fire-extinguishing agent designed to provide protection against fires in large-sized fire-hazardous facilities with electrical equipment such as switchboards, control cabinets, electrical cabinets, safes, etc. The technique according to this patent is a device holding a fire-extinguishing wire in an electric cabinet, having a support for fastening to the inner walls of the electric cabinet and designed in the form of a bending mount having a slot for holding the wire, and the base of the mount has an adhesive layer. The disadvantage of this technique is the complexity of a fire-extinguishing wire installation, associated with the need to install the claimed mean of fastening to the inner walls of the electrical cabinet along its perimeter, after which the fire-extinguishing wire is fastened in the mount.

A self-working fire-extinguishing device is known (patent RU 184841) which contains a foam housing comprising an explosive device and a fire-extinguishing agent. The explosive device is connected to a fire-conducting wire extending outward through the housing hole, and laid in a closed recess designed from the outside of the housing along its perimeter, and the width of the recess exceeds the width of the fire-conducting wire. To facilitate the rupture of the housing when an explosive device is triggered, grooves are designed on the inside of the housing. This device is suspended from a bracket or placed on a flat surface and independently activates when the flame contacts the fire-conducting wire. The disadvantage of this technique is that the fire-extinguishing device is placed in a guarded room with electrical equipment using a bracket or installed on a flat surface limiting its location options and reduces the effectiveness of fire extinguishing.

An automatic fire-extinguishing device for telecommunication equipment is known which is placed in a standard closed-type telecommunications rack (TCR) (patent RU 190222). The device is a single structure containing a housing comprising a flame-extinguishing agent generator (FEAG); the flame-extinguishing agent generator consists of two containers that are connected to a flame-extinguishing agent delivery system to the ignition source, consisting of pipelines and FEAG nozzles. The device triggering unit is designed in the form of an external linearly extended sensor, which is routed through the most heat-loaded areas of the TCR and connected to the input of the device, which, in turn, is connected inside the device to a sensor exceeding the temperature threshold. Additionally, this device comprises an alarm device (a light and sound indicator) indicating the fact that the generator has produced a flame-extinguishing agent. In this automatic fire-extinguishing device, standard flame-extinguishing agents are offered for use; they are characterized by insufficient extinguishing capacity and are unsafe in their chemical composition. It reduces the effectiveness of extinguishing, and the presence of pipelines and nozzles for supplying a flame-extinguishing agent to a guarded room increases the complexity of manufacturing the device, as well as installing the device in other types of rooms with electrical equipment is characterized by increased complexity of manufacturing in due to the use of standard methods of fastening to the TCR.

An autonomous fire-extinguishing device with a fastening on a DIN rail is known (patent RU 204767), comprising a housing that has a fire-extinguishing aerosol generator (FAG) with a triggering unit is located; FAG is constructed in the form of a housing designed using a non-flammable material with an outlet nozzle into which an aerosol-forming or gas-forming composition (AFC) is placed, and the housing of automatic firefighting system comprises nozzle openings for the output of an aerosol-forming or gas-forming composition and a slot for attaching the housing from FAG to a DIN rail, and the triggering unit comprises the form of a self-igniting thermal wire. Preferably, the triggering unit comprises the form of a self-igniting thermal wire with a heat-sensitive element; the activation temperature is less than the activation temperature of the thermal wire. The disadvantage of this device is that the applicable heat-sensitive element has high actuation temperatures, namely, it is known that such heat-sensitive initiators are triggered at a temperature of at least 150° C.-180° C. allowing not to provide a rapid response to an increase in temperature during ignition and greatly delays the start of the extinguishing cycle. This technique is the closest analogous solution to the claimed utility model and can act as a prototype.

### DISCLOSURE OF INVENTION

The technical problem that the claimed solution is aimed at is the creation of a compact fire-extinguishing device for electrical equipment located in switchboards, electrical cabinets, cabinets of telecommunications equipment, etc., with high fire-extinguishing capacity, a wide range of operational capabilities either with the possibility of fastening the proposed device to a DIN rail or without it, having the possibility of initiation by an external electrical signal or initiation from an internal or external heat-sensitive device, a smoke sensor, as well as capable of generating an information signal of the device's triggering.

The technical result of the claimed patent is to solve the specified technical problem and implement the claimed electrically triggered fire-extinguishing device.

The specified technical result is achieved by means of a fire-extinguishing device (FED) with an aerosol-forming or gas-forming composition placed inside (AFC module) containing an AFC module (1), an electric igniter (7) of the AFC module and a triggering heat-sensitive device (4) connected serially by conductors to each other.

Alternatively, the FED additionally comprises a contact group (10) for triggering through conductors by an external signal of the electric igniter (7) of the AFC module or the supply of a triggering voltage to the triggering heat-sensitive device (4) and the electric igniter (7) of the AFC module; a triggering sensor (11) and a manual start button (18) of the electric igniter (7) of the AFC module; the triggering sensor (11) is located in the immediate vicinity of the AFC module or in the AFC module, connected by conductors (17) to the contact group (10); the manual start button (18) of the electric igniter (7) of the AFC module is connected through conductors to the electric igniter (7) of the AFC module.

Alternatively, the aerosol-forming or gas-forming composition of the FED is a low-temperature solid fuel composition.

Alternatively, the device additionally comprises a smoke detector (13) with or without a power and control system connected by conductors to a triggering heat-sensitive device (4) serially or in parallel.

Alternatively, the device contains a DIN rail mount, which is a slot for a DIN rail located on the back of the device housing, in which a latch mount is installed to fasten the housing on the DIN rail.

Alternatively, holes are additionally configured with a housing comprising holes for the output of an aerosol-forming or gas-forming composition.

### EMBODIMENT OF INVENTION

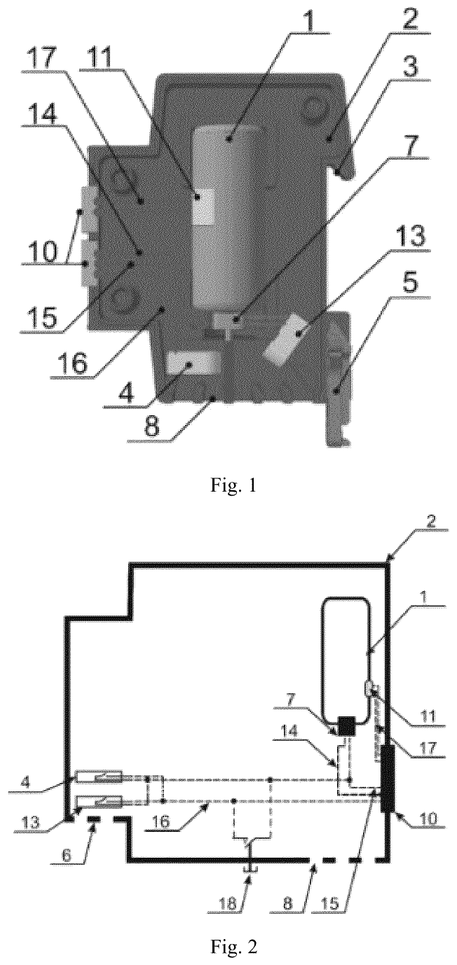

FIG. 1 and FIG. 2 show the type and scheme of the claimed FED, where 1—AFC module, 2—mounting housing, 3—slot for mounting the housing to the DIN rail, 4—triggering heat-sensitive device, 5—latch mount, 7—electric igniter of the AFC module, 8—nozzle openings for the output of an aerosol-forming or gas-forming composition, 10—contact group for connecting external wires for an electric igniter and an initiating heat-sensitive device, 11—triggering sensor of the AFC module, 13—smoke sensor for triggering the electric igniter of the AFC module (may be missing in the device), (14-15)—conductors for external triggering of the electric igniter of the AFC module, (14-16)—conductors connecting the contact group to the triggering heat-sensitive device and the electric igniter of the AFC module, 17—conductors connecting the contact group to the triggering sensor of the AFC module, 18—manual start button for the electric igniter of the AFC module.

The FED comprises the AFC module (1) and a compact housing (2). The housing (2) comprises AFC module (1) and AFC module comprises nozzle openings for the output of an aerosol-forming or gas-forming composition (8), and the triggerring unit of the AFC module is an electric igniter (7) of the AFC module.

After applying voltage through the contact group (10) and wires (14) (15) to the electric igniter (7) of the AFC module, the AFC module (1) is triggered allowing remote triggering of the FED by means of an external signal.

The electric igniter (7) of the AFC module is started by a triggering heat-sensitive device (4) connected to a contact group (10), and the contact group is connected simultaneously to conductors (16) and (14), to which the triggering voltage of the electric igniter (7) of the AFC module is pre-applied. When the triggering heat-sensitive device (4) is triggered, voltage is applied to the electric igniter (7) of the AFC module, which in turn triggers the AFC module (1).

Also, the electric igniter (7) of the AFC module is triggered by a smoke sensor (13) with or without a control system (not shown in the figure) connected to a contact group (10), and the contact group is connected simultaneously to wires (16) and (14), to which the triggering voltage of the electric igniter (7) of the AFC module is pre-applied. When the smoke detector (13) is triggered, voltage is applied to the electric igniter (7) of the AFC module, which in turn triggers the AFC module (1). The smoke sensor (13) can be connected to the triggering heat-sensitive device (4) serially allowing to trigger the electric igniter (7) of the AFC module only when both devices—the smoke sensor (13) and the triggering heat-sensitive device (4)—are triggered simultaneously or in parallel allowing to trigger the electric igniter (7) of the AFC module using any of the triggered sensors, namely the smoke detector (13) or the triggering heat-sensitive device (4).

The triggering sensor (11) of the AFC module, necessary for generating the trigger signal of the AFC module (1), is connected by conductors (17) to the contact group (10), and in the mentioned contact group (10) separate contacts are used for the mentioned connection.

The back of the FED's housing (2) comprises a slot (3); the slot comprises a latch-mount (5) designed to fasten the housing (2) to a DIN rail. In this regard, the housing of the FED can also be fastened to the DIN rail using a screw connection, however, fastening with a DIN rail assembly with a latch-mount (5) is advantageous, for it allows to install the FED in a larger range of locations in the switchboard or cabinet increasing the fire-extinguishing efficiency. Preferably, the specified technical result is achieved in the device by mounting the FED on a DIN rail as follows. The latch-mount (5) is pushed down, the housing (2) comprising the AFC module (1) is placed on the DIN rail, clinging to the upper protrusions of the slot (3), after which the latch-mount (5) closes fastening the FED on the DIN rail. The removal of the FED from the DIN rail is carried out in reverse order. Thus, the use of the claimed FED, with the simplicity and compactness of the design, autonomy and reliability of operation, and the simplicity of its installation on a DIN rail, allows to extinguish fire in the electrical equipment located in cabinet-type rooms with high efficiency.

1. A fire-extinguishing device (FED) comprising a module (1) with aerosol-forming or gas-forming composition; module (1) comprises an electric igniter (7) of the module (1) and an triggering heat-sensitive device (4) connected serially by conductors to each other, while additionally comprising a contact group (10) for triggering an external electrical signal through the conductors by the external signal of the electrical igniter (7) of the module or the supply of triggering voltage to the triggering heat-sensitive device (4) and the electric igniter (7) of the module; the triggering sensor (11) and the manual start button (18) of the electric igniter (7) of the module (1); the trigger sensor (11) is connected by conductors (17) to the contact group (10); the manual start button (18) of the electric igniter (7) of the module (1) is connected through conductors to the electric igniter (7) of the module (1).

2. The device according to claim 1, characterized by a low-temperature solid fuel aerosol-forming or gas-forming composition.

3. The device according to claim 1, characterized by an additional smoke sensor (13) with a power and control system connected by conductors to a triggering heat-sensitive device (4) serially or in parallel.

4. The device according to claim 1, characterized by a provision of a DIN rail fastening, which is a slot for a DIN rail located on the back of the device housing, in which a latch-mount is installed to fasten the housing on the DIN rail.

5. A device according to claim 1, characterized by additional housing holes for the output of an aerosol-forming or gas-forming composition.
